(19) United States
(12) Patent Application Publication
(10) Pub. No.: US 2024/0396196 A1
(43) Pub. Date: Nov. 28, 2024

(54) FREQUENCY SELECTIVE SUBSTRATE ASSEMBLIES

(71) Applicant: CORNING INCORPORATED, CORNING, NY (US)

(72) Inventors: Hyeng-cheul Choi, Seoul (KR); Byounggwan Kang, Seoul (KR); Choonkon Kim, Cheonan-si (KR); Hyung Soo Moon, Seoul (KR)

(21) Appl. No.: 18/713,767

(22) PCT Filed: Nov. 18, 2022
(86) PCT No.: PCT/US22/50339

§ 371 Date: May 28, 2024

Related U.S. Application Data
(60) Provisional application No. 63/284,158, filed on Nov. 30, 2021.

(51) Int. Cl. H01P 1/20; B32B 7/02; B32B 7/12; B32B 17/06

(52) U.S. Cl. CPC H01P 1/20; B32B 7/02; B32B 7/12; B32B 17/06; B32B 2307/202; B32B 2307/204; B32B 2307/41; B32B 2307/7376; B32B 2307/748

(57) ABSTRACT

A substrate assembly includes a first substrate and a second substrate each comprising an inner surface opposite an outer surface, a conductive material layer disposed on the inner surface of the second substrate, and an adhesive layer disposed between the inner surface of the first substrate and the inner surface of the second substrate such that the conductive material layer is positioned between the inner surface of the second substrate and the adhesive layer and the adhesive layer bonds the first substrate to the second substrate, wherein the substrate assembly comprises a reflection coefficient of 0.7 or less.

### CROSS-REFERENCE TO RELATED APPLICATIONS

This application claims the benefit of priority under 35 U.S.C. § 119 of U.S. Provisional Application No. 63/284,158 filed Nov. 30, 2021, the content of which is incorporated herein by reference in its entirety.

### FIELD

The present specification generally relates to substrate assemblies, and particularly, to frequency selective substrate assemblies.

### TECHNICAL BACKGROUND

The wireless transmission and reception of data using wireless communication technology standards such as 4G, 5G, and so forth, suffer from propagation loss and reflection loss, e.g., due to the presence of obstacles. Repeaters that include semiconductor amplifiers may partially mitigate instances of propagation and reflection loss, but large numbers of these repeaters need to be installed near base stations, making the process cost ineffective. Frequency selective surfaces also partially mitigate propagation and reflection loss, but these surfaces may include substrates that generate unintended reflections.

Accordingly, a need exists for frequency selective substrate assemblies that reduces propagation and reflection loss and unintended signal reflections from one or more layers included within the substrate assembly.

### SUMMARY

According to a first aspect of the present disclosure, a frequency selective substrate assembly comprises a first substrate and a second substrate each comprising an inner surface opposite an outer surface, a conductive material layer disposed on the inner surface of the second substrate, and an adhesive layer disposed between the inner surface of the first substrate and the inner surface of the second substrate such that the conductive material layer is positioned between the inner surface of the second substrate and the adhesive layer and the adhesive layer bonds the first substrate to the second substrate, wherein the substrate assembly comprises a reflection coefficient of 0.7 or less.

A second aspect of the present disclosure includes the frequency selective substrate assembly of the first aspect, wherein the conductive material layer comprises a transparent conductive oxide, a conductive polymer, a carbon nanotube wire, graphene, or a metal mesh.

A third aspect of the present disclosure includes the frequency selective substrate assembly of the first aspect or the second aspect, wherein each of the first substrate and the second substrate comprises glass having an average transmittance greater than 80% over a wavelength range from about 300 nm to about 800 nm.

A fourth aspect of the present disclosure includes the frequency selective substrate assembly of any of the first through the third aspects, wherein the adhesive layer comprises a material having a tensile strength that is equal to or greater than 1 Newton per centimeter.

A fifth aspect of the present disclosure includes the frequency selective substrate assembly of any of the first through the fourth aspects, wherein the adhesive layer comprises an average transmittance greater than 80% over a wavelength range from about 300 nm to about 800 nm.

A sixth aspect of the present disclosure includes the frequency selective substrate assembly of any of the first through the fifth aspects, wherein the frequency selective substrate assembly comprises the reflection coefficient of 0.7 or less at an operation frequency of 28 GHz.

A seventh aspect of the present disclosure includes the frequency selective substrate assembly of any of the first through the sixth aspects, wherein a dielectric constant of the adhesive layer is in a range of 2 to 4 and a thickness of the adhesive layer is in a range of 25 micrometers to 175 micrometers.

An eighth aspect of the present disclosure includes the frequency selective substrate assembly of any of the first through the seventh aspects, wherein a thickness of the first substrate is different than a thickness of the second substrate.

A ninth aspect of the present disclosure includes the frequency selective substrate assembly of the any of the first through the eighth aspects, wherein an electric conductivity of the conductive material layer is greater than or equal to 1 million Siemens per meter (S·m⁻¹).

A tenth aspect of the present disclosure includes the frequency selective substrate assembly of the any of the first through the ninth aspects, wherein the second substrate comprises an opaque material.

According to an eleventh aspect of the present disclosure, a frequency selective substrate assembly includes a first substrate and a second substrate each comprising an inner surface opposite an outer surface, an adhesive layer disposed between the first substrate and the second substrate, the adhesive layer coupling the first substrate to the second substrate, a first conductive material layer deposited on the inner surface of the first substrate, and a second conductive material layer deposited on the inner surface of the second substrate, wherein the frequency selective substrate assembly comprises a reflection coefficient of 0.7 or less.

A twelfth aspect of the present disclosure includes the frequency selective substrate assembly of the eleventh aspect, wherein each of the first conductive material layer and the second conductive material layer comprises a transparent conductive oxide, a conductive polymer, a carbon nanotube wire, graphene, or a metal mesh.

A thirteenth aspect of the present disclosure includes the frequency selective substrate assembly of the eleventh aspect or the twelfth aspect, wherein each of the first substrate and the second substrate comprises glass having an average transmittance greater than 80% over a wavelength range from about 300 nm to about 800 nm.

A fourteenth aspect of the present disclosure includes the frequency selective substrate assembly of any of the eleventh through the thirteenth aspects, wherein the adhesive layer comprises a material having a tensile strength that is equal to or greater than 1 Newton per centimeter.

A fifteenth aspect of the present disclosure includes the frequency selective substrate assembly of any of the eleventh through the fourteenth aspects, wherein the adhesive layer comprises an average transmittance greater than 80% over a wavelength range from about 300 nm to about 800 nm.

A sixteenth aspect of the present disclosure includes the frequency selective substrate assembly of any of the eleventh through the fifteenth aspects, wherein the frequency selective substrate assembly comprises the reflection coefficient of 0.7 or less at an operation frequency of 28 GHz.

A seventeenth aspect of the present disclosure includes the frequency selective substrate assembly of any of the eleventh through the sixteenth aspects, wherein a dielectric constant of the adhesive layer is in a range of 2 to 4 and a thickness of the adhesive layer is in a range of 25 micrometers to 175 micrometers.

An eighteenth aspect of the present disclosure includes the frequency selective substrate assembly of any of the eleventh through the seventeenth aspects, wherein a thickness of the first substrate is different than a thickness of the second substrate.

A nineteenth aspect of the present disclosure includes the frequency selective substrate assembly of any of the eleventh through the eighteenth aspects, wherein an electric conductivity of each of the first conductive material layer and the second conductive material layer is greater than or equal to 1 million Siemens per meter (S·m⁻¹).

A twentieth aspect of the present disclosure includes the frequency selective substrate assembly of any of the eleventh through the nineteenth aspects, wherein the second substrate comprises an opaque material.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description describe various embodiments and are intended to provide an overview or framework to understanding the nature and character of the claimed subject matter.

The accompanying drawings are included to provide a further understanding of the various embodiments, and are incorporated into and constitute a part of this specification. The drawings illustrate the various embodiments described herein, and together with the description serve to explain the principles and operation of the claimed subject matter.

### BRIEF DESCRIPTION OF THE SEVERAL VIEWS OF THE DRAWINGS

FIG. 1A depicts a substrate assembly in which a conductive material is deposited on an inner surface of a first substrate, according to one or more embodiments described and illustrated herein;

FIG. 1B schematically depicts a substrate assembly in which a conductive material is deposited on an inner surface of the first substrate and on an inner surface of the second substrate, according to one or more embodiments described and illustrated herein;

FIG. 2A depicts a substrate assembly in which a conductive material is deposited on an inner surface of a second substrate, according to one or more embodiments described and illustrated herein;

FIG. 2B schematically depicts a substrate assembly in which a conductive material is deposited on an inner surface of the first substrate and on an inner surface of the second substrate, according to one or more embodiments described and illustrated herein;

FIG. 3 schematically depicts incident wave reflection trajectories from a substrate assembly that includes a first substrate and an adhesive layer and a conductive material layer deposited on the inner surface of the first substrate, according to one or more embodiments described and illustrated herein;

FIG. 4 schematically depicts incident wave reflection trajectories from a substrate assembly that includes a first substrate, a second substrate, an adhesive layer on the inner surface of the first substrate and the second substrate, and conductive material layers deposited on the inner surface of the first substrate and the second substrate, according to one or more embodiments described and illustrated herein;

FIG. 5 graphically depicts the reflection coefficient (y-axis) as a function of the thickness of the first substrate (x-axis) of the substrate assembly as depicted in FIG. 3, according to one or more embodiments described and illustrated herein;

FIG. 6 graphically depicts the reflection coefficient (y-axis) as a function of the thickness of the second substrate (x-axis) for the substrate assembly as depicted in FIG. 4, according to one or more embodiments described and illustrated herein;

FIG. 7A schematically depicts a signal, such as a 28 GHz signal, contacting an object without a frequency selective substrate assembly and scattering in multiple directions; and

FIG. 7B schematically depicts a signal containing an object comprising a reflector having a frequency selective substrate assembly according to one or more embodiments shown and described herein.

### DETAILED DESCRIPTION

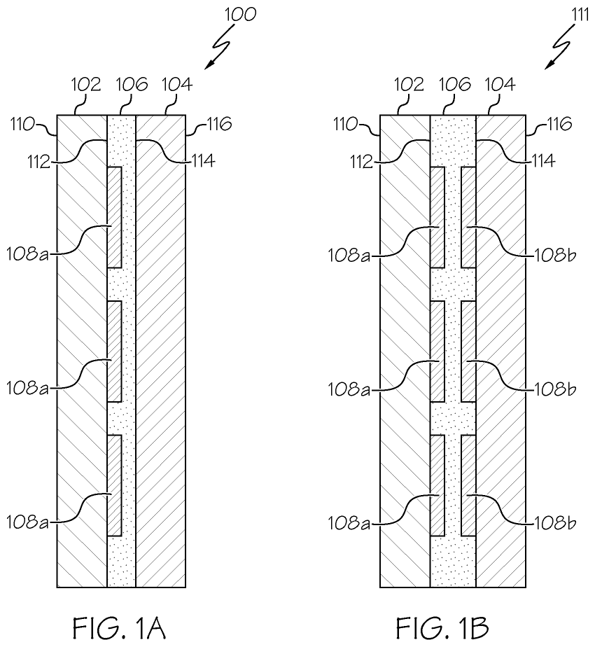

Reference will now be made in detail to embodiments of frequency selective substrate assemblies, embodiments of which are illustrated in the accompanying drawings. Whenever possible, the same reference numerals will be used throughout the drawings to refer to the same or like parts. One embodiment of a frequency selective substrate assembly is schematically depicted in FIGS. 1A and 1B. The substrate assembly generally includes a first substrate and a second substrate each comprising an inner surface opposite an outer surface, a conductive material layer disposed on the inner surface of the second substrate, and an adhesive layer disposed between the inner surface of the first substrate and the inner surface of the second substrate such that the conductive material layer is positioned between the inner surface of the second substrate and the adhesive layer. The adhesive layer may bond the first substrate to the second substrate. Additionally, the substrate assembly comprises a reflection coefficient of 0.7 or less. Various embodiments of substrate assemblies for use as frequency selective surfaces will be described herein with specific reference to the appended drawings.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Transmittance data is measured with a Lambda 950 UV/Vis Spectrophotometer manufactured by PerkinElmer Inc. (Waltham, Massachusetts USA). The Lambda 950 apparatus was fitted with a 150 mm integrating sphere. Data was collected using an open beam baseline and a Spectralon R reference reflectance disk. For total transmittance (Total Tx), the sample is fixed at the integrating sphere entry point.

The term “average transmittance,” as used herein, refers to the average of transmittance measurements made within a given wavelength range with each whole numbered wavelength weighted equally. In the embodiments described herein, the “average transmittance” is reported over the wavelength range from 300 nm to 800 nm (inclusive of endpoints).

The wireless transmission and reception of data results in propagation and reflection losses due to the signals contacting and scattering from various obstacles, such as objects in the environment through which the signal propagates. While the use of repeaters may partially mitigate such losses, a plurality of repeaters installed in and around, e.g., base stations, may make the use of repeaters expensive. The use of frequency selective surfaces may also partially mitigate propagation and reflection loss, but these surfaces may include multiple substrates that generate unintended reflections, in particular, due to differences in the values of relative dielectric constants between one or more layers included within these substrates.

The substrate assemblies described herein overcome the above-identified deficiencies. For example, embodiments of the substrate assemblies described herein may include a first substrate and a second substrate each comprising an inner surface opposite an outer surface, a conductive material layer disposed on the inner surface of the second substrate, and an adhesive layer disposed between the inner surface of the first substrate and the inner surface of the second substrate such that the conductive material layer is positioned between the inner surface of the second substrate and the adhesive layer. The adhesive layer may bond the first substrate to the second substrate. Additionally, the substrate assembly comprises a reflection coefficient of 0.7 or less.

Such substrate assemblies limit instances of unwanted signal reflections from one or more layers within the substrate in addition to reducing instances of signals reflections from the conductive material layers included within substrate assemblies. In embodiments, it is noted that the use of two substrates results in limiting instances of unwanted signal reflection to a greater extent than the use of a single substrate, e.g., at least with respect to signals with an operational frequency of 28 GHz.

FIG. 1A depicts a frequency selective substrate assembly 100 in which a conductive material layer 108a is deposited on an inner surface 112 of a first substrate 102, according to one or more embodiments described and illustrated herein. The frequency selective substrate assembly 100 includes the first substrate 102, the second substrate 104, an adhesive layer 106, and the conductive material layer 108a. The first substrate 102 comprises an outer surface 110 and the inner surface 112, and the second substrate 104 includes an inner surface 114 and an outer surface 116. In the embodiments illustrated in FIG. 1A, the inner surface 112 of the first substrate 102 of the frequency selective substrate assembly 100 may be positioned opposite the inner surface 114 of the second substrate 104 and the adhesive layer 106 may be positioned between the respective inner surfaces 112, 114 of the first substrate 102 and the second substrate 104. The adhesive layer 106 enables the direct coupling of the first substrate 102 to the second substrate 104.

In embodiments, each of the first substrate 102 and the second substrate 104 may be formed from an optically transparent material such as, e.g., glass. It is noted that the glass that is utilized to form each of the first substrate 102 and the second substrate 104 is one that possesses characteristics of low permittivity and low signal loss levels. In embodiments, the glass that is utilized to form each of the first substrate 102 and the second substrate 104 has an average transmittance that is greater than or equal to 80% over the wavelength range from about 300 nanometers to about 800 nanometers. In embodiments, the average transmittance of the glass from which the first substrate 102 and the second substrate 104 are formed may be greater than or equal to 85%, greater than or equal to 90%, greater than or equal to 92%, or even greater than or equal to 95% over the wavelength range from about 300 nm to about 800 nm.

In embodiments, the first substrate 102 may be formed of an optically transparent material such as glass and the second substrate 104 may be formed of a plastic such as, e.g., polymethyl methacrylate (PMMA), wood, metal plate (e.g., steel), or other such comparable materials. In embodiments, the second substrate 104 may be an opaque material. In these embodiments, the glass that is utilized to form the first substrate 102 has an average transmittance that is greater than or equal to 80% over the wavelength range from about 300 nanometers to about 800 nanometers. In these embodiments, the average transmittance of the glass from which the first substrate 102 is formed may be greater than or equal to 85%, greater than or equal to 90%, greater than or equal to 92%, or even greater than or equal to 95% over the wavelength range from about 300 nm to about 800 nm.

In embodiments, the thickness of each of the first substrate 102 and the second substrate 104 may be in the range of 0.1 to 3.0 millimeters, such as 0.2 millimeters to 2.2 millimeters, e.g., based on an operational frequency of 28 Gigahertz (“GHz”). It is noted, however, that the thickness of the substrates may vary depending on the operational frequency with which the frequency selective substrate assembly is intended for use. For example, an increase in the operational frequency will require a reduction in the thickness of the substrates to maintain a threshold level of operational effectiveness (e.g., the desired reflection coefficient of the substrate assembly). In embodiments, the first substrate 102 and the second substrate 104 may have different thicknesses. For example, in embodiments, the first substrate 102 may have a thickness in a range of 0.3 mm to 0.7 mm and the second substrate 104 may have a thickness that is higher than approximately 1 mm.

In one embodiments, the glass may have low permittivity and low loss in the mm wave band. In embodiments, the glass may be formed of alkaline earth boro-aluminosilicate glass. In embodiments, the glass may have a low coefficient of thermal expansion (CTE) such that variations in temperatures have minimal effect on the length of the conductive material layer 108a deposited on, e.g., the inner surface 112 of the first substrate 102. As such, the glass may generate a consistent or stable frequency response. In embodiments, the relative dielectric constant of the glass may be less than 6 in order to facilitate low reflection of electromagnetic waves from the glass.

In the embodiment depicted in FIG. 1A, the conductive material layer 108a is formed directly on the inner surface 112 of the first substrate 102. Various techniques may be used to form the conductive material layer 108a on the inner surface 112 of the first substrate 102, including, without limitation, physical vapor deposition, electron beam (E-beam) deposition, electroless plating, electroplating, and the like. When deposited on the inner surface 112 of the first substrate 102, the conductive material layer 108a is disposed between the adhesive layer 106 and the inner surface 112 of the first substrate 102 such that the conductive material layer 108a is directly coupled to both the inner surface 112 of the first substrate 102 and the adhesive layer 106.

In embodiments, the conductive material layer 108a may comprise a conductive polymer, carbon nanotube wire, graphene, a metallic thin film, a metal mesh, a transparent conductive oxide, etc. Examples of suitable metallic materials include, for example and without limitation, copper, gold, nickel, aluminum, and tungsten, or other materials having similar electrical properties. In embodiments, the conductive material layer 108a may be formed of a material that has an electrical conductivity greater than or equal to 1 million Siemens per meter (S·m⁻¹) as deposited on the inner surface 112 of the first substrate 102. In embodiments, the conductive material layer 108a may be deposited onto the inner surface 112 of the first substrate 102 in an interconnected pattern, such as a grid pattern, a diamond pattern, a web pattern or the like. For example and without limitation, the conductive material layer 108a may be deposited in the form of a grid pattern comprising a plurality of interconnected lines. The grid pattern may be a rectangular grid pattern, a square grid pattern or the like.

In embodiments, the conductive material layer 108a may be deposited on the inner surface 112 of the first substrate 102 without corresponding to a regular pattern. It is noted that, regardless of pattern (or the absence of a regular pattern), the conductive material layer 108a is interconnected.

In embodiments, the thickness of the conductive material layer 108a deposited on the inner surface 112 of the first substrate 102 is dependent on the intended operational frequency of the substrate assembly. In particular, the thickness of the conductive material layer 108a may be based on the operational frequency according to the following equation:

$${δ}_{s} = \sqrt{\frac{1}{π * f * μ * σ}}$$

in which “δs”, in units of meters (m), corresponds to “skin depth”, which corresponds to the thickness of the conductive material layer 108a. In embodiments, the thickness of the conductive material layer 108 may be a multiple of the skin depth value, e.g., one multiple (1×) of the value of the skin depth, two multiples (2×) of the value of the skin depth, three multiples (3×) of the value of skin depth, and so forth. The term “u” refers to permeability (H/m) of the conductive material layer 108a, the term “f” refers to the frequency (Hz) at which the substrate assembly is intended to operate (e.g., 28 GHz), and the term “o” corresponds to conductivity (mho/m) of the conductive material layer 108a.

In embodiments, to increase the strength of the bond between the inner surface 112 of the first substrate 102 and the conductive material layer 108a, materials such as titanium or chromium may be included as part of the conductive material layer 108a or within both the conductive material layer 108a and the inner surface 112 of the first substrate 102.

In embodiments, the conductive material layer 108a may be deposited at a thickness such that the conductive material layer 108a is optically transparent. That is, the conductive material layer 108a may have a suitable thickness such that the conductive material layer 108a has an average transmittance that is greater than or equal to 80% over the wavelength range from about 300 nm to about 800 nm. In embodiments, the average transmittance of the conductive material layer 108a may be greater than or equal to 85%, greater than or equal to 90%, greater than or equal to 92%, or even greater than or equal to 95% over the range from about 300 nm to about 800 nm.

In embodiments, the adhesive layer 106 may have a thickness in the range from 25 micrometers to 175 micrometers or even 50 micrometers to 175 micrometers. In embodiments, the thickness of the adhesive layer 106 may be from about 25 micrometers to about 150 micrometers, from about 25 micrometers to about 125 micrometers, from about 25 micrometers to about 100 micrometers, from about 25 micrometers to about 75 micrometers, from about 25 micrometers to about 50 micrometers, or any range formed from any of these endpoints. In embodiments, the thickness of the adhesive layer 106 may be from about 50 micrometers to about 150 micrometers, from about 50 micrometers to about 125 micrometers, from about 50 micrometers to about 100 micrometers, from about 50 micrometers to about 75 micrometers or any range formed from any of these endpoints. Additionally, the adhesive layer 106 may have a dielectric constant in a range of 2 to 4 to minimize the reflection of electromagnetic waves from the adhesive layer.

It is noted that the adhesive layer 106 may be formed of a material having a tensile strength greater than or equal to 1 Newton per centimeter (1 N/cm) to ensure that the first substrate 102 is bonded to the second substrate 104 and that the bond or coupling is maintained. In other words, the adhesive layer 106 may have a tensile strength greater than or equal to 1 N/cm to ensure that the first substrate 102 does not separate from the second substrate 104 subsequent to the bonding.

In embodiments, the adhesive layer 106 may be in the form of an optically clear adhesive (“OCA”) having an average transmittance that is greater than or equal to 80% over the wavelength range from about 300 nanometers to about 800 nanometers. In embodiments, the average transmittance of the adhesive layer 106 may be greater than or equal to 85%, greater than or equal to 90%, greater than or equal to 92%, or even greater than or equal to 95% over the wavelength range from about 300 nm to about 800 nm.

In embodiments, the adhesive layer 106 may be a TTC-NW series adhesive from the TMS Company applied at a thickness of 50 micrometers. However, it should be understood that other types of OCA material may be used and that the adhesive layer may be applied at different thicknesses with the range from about 50 micrometers to about 175 micrometers.

Still referring to FIG. 1A, the frequency selective substrate assembly 100 reduces propagation and reflection losses for an incident electromagnetic signal and also reduces unintended signal reflections by preventing the scattering of the signal incident on one or more surfaces of the frequency selective substrate assembly 100. In other words, the frequency selective substrate assembly 100 may reflect signals that contact one or more surfaces of the frequency selective substrate assembly 100 with a high level of fidelity and uniformity such that a significant amount of the originally contacted signal may be reflected outward. In this way, unintended signal and propagation losses are mitigated. These characteristics of the frequency selective substrate assembly 100 are indicated by the substrate assembly comprising a reflection coefficient of 0.7 or less at the intended operational frequency (e.g., 28 GHz). In embodiments, the reflection coefficient of the frequency selective substrate assembly 100 may be 0.6 or less, 0.5 or less, 0.4 or less, or even 0.3 or less at the intended operational frequency.

FIG. 1B depicts another embodiment of a frequency selective substrate assembly 111. In this embodiment of the frequency selective substrate assembly 111, a conductive material layer 108a is affixed to the inner surface 112 of the first substrate 102 and a conductive material layer 108b is affixed to the inner surface 114 of the second substrate 104. The first substrate 102 and the second substrate 104 may be as described herein with respect to FIG. 1A. In embodiments, the conductive material layer 108a and the conductive material layer 108b may be affixed to the corresponding inner surfaces 112, 114 using deposition techniques described herein with respect to FIG. 1A. The conductive material layer 108a and the conductive material layer 108b may be formed from the materials described herein with respect to FIG. 1A and the properties of the conductive material layer 108a and the conductive material layer 108b (i.e., thickness, average transmittance, electrical conductivity, etc.) may be as described herein with respect to FIG. 1A.

Additionally, the frequency selective substrate assembly 111 includes the adhesive layer 106 disposed between these substrates such that these substrates are directly coupled to each other through the adhesive layer 106. When deposited on the inner surface 112 of the first substrate 102, the conductive material layer 108a is disposed between the adhesive layer 106 and the inner surface 112 of the first substrate 102 such that the conductive material layer 108a is directly coupled to both the inner surface 112 of the first substrate 102 and the adhesive layer 106. When deposited on the inner surface 114 of the second substrate 104, the conductive material layer 108b is disposed between the adhesive layer 106 and the inner surface 114 of the second substrate 104 such that the conductive material layer 108b is directly coupled to both the inner surface 114 of the second substrate 104 and the adhesive layer 106. In this embodiment, the adhesive layer 106 may be as described herein with respect to FIG. 1A (i.e., the adhesive layer 106 may be formed from the same material and have the same properties (thickness, average transmittance, tensile strength, etc.)).

Like the frequency selective substrate assembly 100 of FIG. 1A, the frequency selective substrate assembly 111 of FIG. 1B may have a reflection coefficient of 0.7 or less at the intended operational frequency (e.g., 28 GHz). In embodiments, the reflection coefficient of the frequency selective substrate assembly 111 may be 0.6 or less, 0.5 or less, 0.4 or less, or even 0.3 or less at the intended operational frequency.

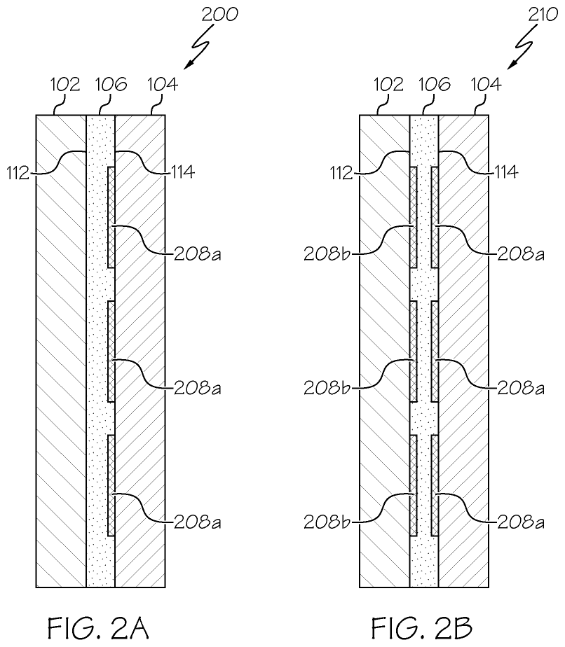

FIG. 2A depicts another embodiment of a frequency selective substrate assembly 200 in which an example conductive material layer 208a may be deposited on the inner surface 114 of the second substrate 104, according to one or more embodiments described and illustrated herein. In this embodiment, the first substrate 102, the adhesive layer 106, and the conductive material layer 208a may be the same (i.e., formed from the same materials, have the same average transmittance, etc.) as the first substrate 102, the adhesive layer 106, and the conductive material layer 108a as described herein with respect to FIG. 1A. In particular, FIG. 2A depicts the frequency selective substrate assembly 200 that includes the first substrate 102 as illustrated in FIG. 1A, the second substrate 104, and the adhesive layer 106 that is positioned between the first substrate 102 and the second substrate 104. It is noted that the second substrate 104, unlike in FIG. 1A, may be formed of a non-transparent or opaque material. Additionally, the example conductive material layer 208a, when deposited on the inner surface 114 of the second substrate 104, is disposed between the adhesive layer 106 and the inner surface 114 of the second substrate 104 such that the conductive material layer 208a is directly coupled to both the inner surface 114 of the second substrate 104 and the adhesive layer 106.

Like the frequency selective substrate assembly 100 of FIG. 1A and the frequency selective substrate assembly of FIG. 1B, the frequency selective substrate assembly 200 of FIG. 2A may have a reflection coefficient of 0.7 or less at the intended operational frequency (e.g., 28 GHZ). In embodiments, the reflection coefficient of the frequency selective substrate assembly 200 may be 0.6 or less, 0.5 or less, 0.4 or less, or even 0.3 or less at the intended operational frequency.

FIG. 2B schematically depicts another embodiment of a frequency selective substrate assembly 210 in which the example conductive material layer 208a and an example conductive material layer 208b are deposited on inner surfaces 112, 114 of the first substrate 102 and a second substrate 104, respectively. In this embodiment, the first substrate 102, the adhesive layer 106, the conductive material layer 208a and the conductive material layer 208b may be the same (i.e., formed from the same materials, have the same average transmittance, etc.) as the first substrate 102, the adhesive layer 106, the conductive material layer 108a, and the conductive material layer 108b as described herein with respect to FIG. 1B. In particular, FIG. 2B depicts the frequency selective substrate assembly 210 that includes the first substrate 102, the second substrate 104, the adhesive layer 106 that is positioned between the first substrate 102 and the second substrate 104.

It is noted that the second substrate 104 may be formed of a non-transparent or opaque material. The example conductive material layers 208a and 208b may be deposited on the inner surfaces 112, 114. The example conductive material layer 208a, when deposited on the inner surface 114 of the second substrate 104, is disposed between the adhesive layer 106 and the inner surface 114 of the second substrate 104 such that the conductive material layer 208a is directly coupled to both the inner surface 114 of the second substrate 104 and the adhesive layer 106. The example conductive material layer 208b, when deposited on the inner surface 112 of the first substrate 102, is disposed between the adhesive layer 106 and the inner surface 112 of the first substrate 102 such that the conductive material layer 208b is directly coupled to both the inner surface 112 of the second substrate 104 and the adhesive layer 106.

Like the frequency selective substrate assembly 100 of FIG. 1A, the frequency selective substrate assembly of FIG. 1B, and the frequency selective substrate assembly 200 of FIG. 2A, the frequency selective substrate assembly 210 of FIG. 2B may have a reflection coefficient of 0.7 or less at the intended operational frequency (e.g., 28 GHz). In embodiments, the reflection coefficient of the frequency selective substrate assembly 200 may be 0.6 or less, 0.5 or less, 0.4 or less, or even 0.3 or less at the intended operational frequency.

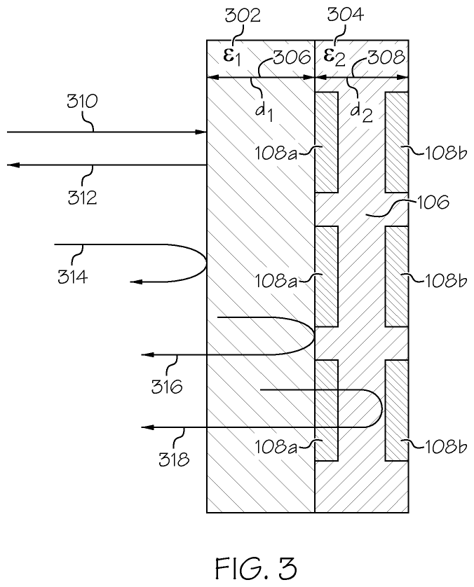

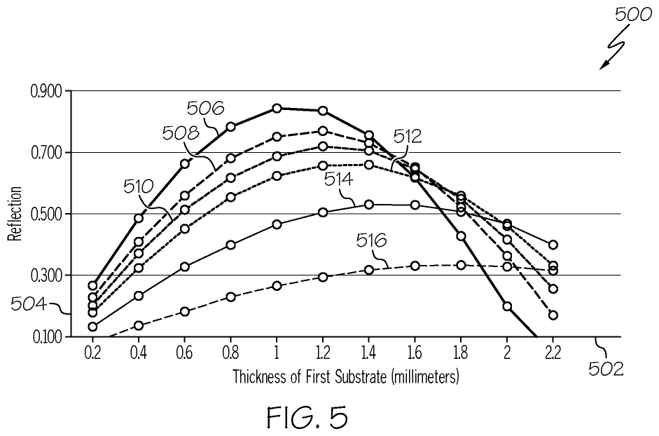

FIG. 3 schematically depicts a model of incident wave reflection trajectories from a substrate assembly that includes a first substrate 102, an adhesive layer 106, a conductive material layer 108a deposited on the inner surface 112 of the first substrate 102, and a conductive material layer 108b deposited on the adhesive layer 106 opposite the conductive material layer 108. The second substrate has been omitted for purposes of modeling the effect of the thickness of the first substrate on the reflection coefficient of the substrate assembly (discussed further with respect to FIG. 5). As illustrated, the first substrate 102 and the adhesive layer 106 have respective dielectric constants of, e.g., ε₁ (302) and ε₂ (304), and respective thickness values of d₁ (306) and d₂ (308). Additionally, an incident wave or signal that propagates and contacts the first substrate 102 may have an incident wave contact trajectory 310, as illustrated in FIG. 3. The surface that such an incident wave will initially contact is the outer surface 110 of the first substrate 102, and as such, the properties of the outer surface 110 of the first substrate 102 will significantly influence the determination of a total reflection of the incident wave from the outer surface 110, which is indicated by total reflection trajectory 312.

Portions of the incident wave that contact the outer surface 110 may be reflected from the outer surface 110 without penetrating any part of the first substrate 102, as indicated by outer surface reflection trajectory 314. However, other portions of the incident wave may penetrate past the outer surface 110 and be reflected upon contacting the inner surface 112 of the first substrate 102, as indicated by the inner surface reflection trajectory 316. Additionally, yet other portions of the incident wave may penetrate past the inner surface 112, and be reflected upon contacting the adhesive layer 106 that is disposed on the inner surface 112 of the first substrate 102, as indicated by the adhesive layer reflection trajectory 318. However, as illustrated in FIG. 3, the incident wave's reflections are not influenced by contact with the conductive material layer 108 that is deposited on the inner surface 114 of the first substrate 102. In this way, unwanted reflections, in particular, reflections from an incident wave contacting a conductive material layer 108, are reduced or eliminated.

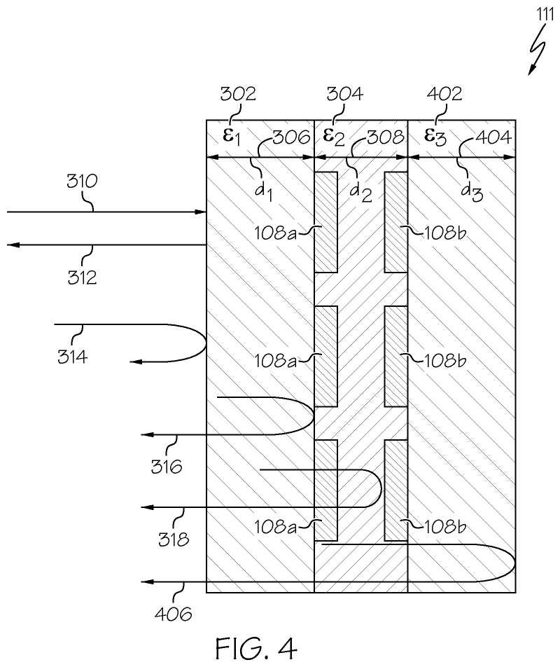

FIG. 4 schematically depicts incident wave reflection trajectories from the frequency selective substrate assembly 111 that includes the first substrate 102, the second substrate 104, and the adhesive layer 106 that is disposed on the inner surface 112 of the first substrate 102 and the inner surface 114 of the second substrate 104, according to one or more embodiments described and illustrated herein. It is noted that the second substrate 104 may have a dielectric constant value of ε₂ (402) and a thickness value of d₃ (404). The incident wave, as described above with respect to FIG. 3, may have the total reflection trajectory 312, the outer surface reflection trajectory 314, the inner surface reflection trajectory 316, and the adhesive layer reflection trajectory 318.

Additionally, as illustrated in FIG. 4, the incident wave may penetrate past the adhesive layer 106 and the second substrate 104, contact the outer surface 116 of the second substrate 104, and be reflected outward, as indicated by the outer surface reflection trajectory 406. The incident wave's reflections are not influenced by contact with the conductive material layer 108, which may be deposited on the inner surface 112 of the first substrate 102 and the inner surface 114 of the second substrate 104. In this way, any unwanted reflections, in particular, reflections from an incident wave contacting a conductive material layer 108, are reduced.

FIG. 5 schematically depicts a graphical representation 500 of reflection curves associated with the substrate assembly depicted in FIG. 3, according to one or more embodiments described and illustrated herein. In particular, the simulation in FIG. 5 shows the effect of the thickness (x-axis) of the first substrate 102 on the reflection coefficient (y-axis). The signal reflections emanating from the substrate may be derived from equations (1)-(4), listed below:

$${Γ}_{i n} = {Γ}_{0} + {Γ}_{1} {e}^{j 2 {β}_{1} {d}_{1}} + {Γ}_{2} {e}^{- j 2 ( {β}_{1} {d}_{1} + {β}_{2} {d}_{2} )} \qquad ( 1 )$$

$${Γ}_{0} = \frac{{η}_{1} - {η}_{0}}{{η}_{1} + {η}_{0}} , {Γ}_{1} = \frac{{η}_{2} - {η}_{1}}{{η}_{2} + {η}_{1}} , {Γ}_{2} = \frac{{η}_{3} - {η}_{2}}{{η}_{3} + {η}_{2}} \qquad ( 2 )$$

$${β}_{n} = \frac{2 π}{{λ}_{n}} where {λ}_{n} = \frac{3 \times 1 {0}^{8}}{Frequency \times \sqrt{{ε}_{n}}} \qquad ( 3 )$$

$${η}_{η} = \sqrt{\frac{{μ}_{n} \times {μ}_{0}}{{ε}_{n} \times {ε}_{0}}} , {ε}_{0} = 8.854 \times 1 {0}^{- 12} F \cdot {m}^{- 1} , {μ}_{0} = 4 π \times 1 {0}^{- 7} H \cdot {m}^{- 1} \qquad ( 4 )$$

In the graphical representation 500, an x-axis 502 corresponds to the thickness of the first substrate, which is listed in millimeters that range from 0.2 millimeters to 2.2 millimeters, and a y-axis 504 corresponds to reflections indicated by reflection coefficients ranging from 0.10 to 0.90. It is noted that the magnitude of a signal reflection from the first substrate 102 may be determined based on various characteristics specific to the substrate such as, e.g., dielectric constant, intrinsic impedance, operation frequency, and a pattern of a conductive material (e.g., the conductive material layer 108 as described above and illustrated in FIGS. 1A-2B) that is deposited on the substrate. Additionally, the derived reflections may be determined based on certain quantitative assumptions, namely that the thickness of the first substrate 102 may be 0.5 millimeters, the relative dielectric constant of the adhesive layer 106 may be 3, the thickness of the adhesive layer 106 may be 50 micrometers, and the permeability of the first substrate 102 may be μ₀.

Regarding the terms in equations (1)-(4), it is noted that “Γᵢₙ” represents the reflection coefficients of the n+1 to the n^{th} substrate. The term “Γ₀” represents a reflection coefficient of air or free-space. Additionally, the term “1” represents the reflection coefficient of the first substrate 102 and the term “Γ₂” represents the reflection coefficient of the second substrate 104. The terms “β₁” and “β₂” represent a phase constant associated with the first substrate 102 and the second substrate 104. In embodiments, the values for β₁ and β₂ are 1244 rad/m and 1015 rad/m, respectively. The terms “d₁” and “d₂” represent the respective thicknesses of the first substrate 102 and the second substrate 104. The term λₙ represents a wavelength within an n^{th} substrate (e.g., the first substrate 102 or the second substrate 104, etc.) and is a function of operation frequency, relative permittivity, and relative permeability. In embodiments, relative permeability of the various components as described in the present disclosure may be 1. The term “ηₙ” represents an intrinsic impedance of a particular substrate and is determined by permittivity and permeability. Additionally, the term “εₙ” represents relative permittivity of substrate “n” and “ε₀” represents absolute permittivity of air or free space. The value of the absolute permittivity of air or free space is 8.854×10⁻¹² F/m. The term “μₙ” represents an absolute permittivity of air or free space. Additionally, it is noted that μ₀ may have a value of 4π×10-7 H/m and the relative dielectric constant of the first substrate 102 may be less than or equal to 4.5.

The derived reflection curves 506, 508, 510, 512, 514, and 516 correspond to the first substrate 102 based on varying permittivity values. However, regardless of the varying permittivity values, these curves have a similar pattern. In particular, the derived reflection curves 506, 508, 510, 512, 514, and 516 indicate that the reflections peak when the thickness values are approximately in the range of 1 millimeter to 1.4 millimeters. When the thickness values are in the range of 1.4 millimeters to 2.2 millimeters, the reflections reduce in magnitude and when the thickness values are in the range of 0.2 to 1.0, the thickness values steadily increase.

It is noted that the parameters included in the equations above and the thickness values described are determined based on and correspond to an operational frequency of 28 GHz. In embodiments, if the operational frequency is increased, e.g., to 39 GHz, the values that are determined above may vary and the thicknesses of the first substrate 102 and the second substrate 104 will be lower. In other words, a variation in the operational frequency may result in a variation in the range of thickness values of 0.2 to 2.2.

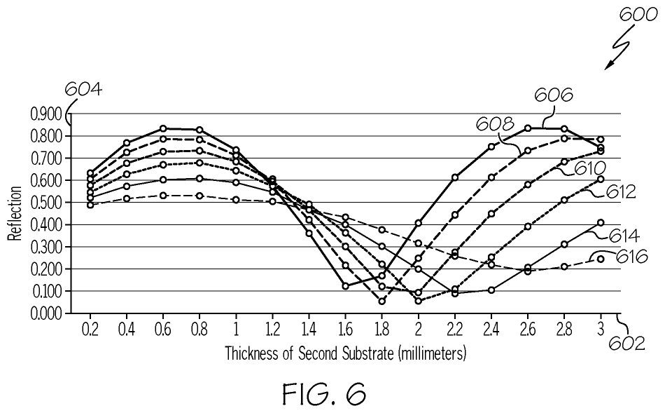

FIG. 6 schematically depicts a graphical representation 600 of reflection curves associated with the frequency selective substrate assembly 111 depicted in FIG. 4, according to one or more embodiments described and illustrated herein. In particular, the simulation in FIG. 6 shows the effect of the thickness (x-axis) of the second substrate 104 on the reflection coefficient (y-axis). Itis noted that the signal reflections illustrated in FIG. 6 are associated with the frequency selective substrate assembly 111 illustrated in FIG. 4, in which the adhesive layer 106 is disposed on the inner surface 112 of the first substrate 102 and the inner surface 114 of the second substrate 104. The signal reflections emanating from the frequency selective substrate assembly 111 illustrated in FIG. 4 may be derived from equations (5)-(8), listed below:

$${Γ}_{i n} = {Γ}_{0} + {Γ}_{1} {e}^{j 2 {β}_{1} {d}_{1}} + {Γ}_{2} {e}^{- j 2 ( {β}_{1} {d}_{1} + {β}_{2} {d}_{2} )} + {Γ}_{3} {e}^{- j 2 ( {β}_{1} {d}_{1} + {β}_{2} {d}_{2} + {β}_{3} {d}_{3} )} \qquad ( 5 )$$

$${Γ}_{0} = \frac{{η}_{1} - {η}_{0}}{{η}_{1} + {η}_{0}} , {Γ}_{1} = \frac{{η}_{2} - {η}_{1}}{{η}_{2} + {η}_{1}} , {Γ}_{2} = \frac{{η}_{3} - {η}_{2}}{{η}_{3} + {η}_{2}} , {Γ}_{3} = \frac{{η}_{4} - {η}_{3}}{{η}_{4} + {η}_{3}} , \qquad ( 6 )$$

$${β}_{n} = \frac{2 π}{{λ}_{n}} where {λ}_{n} = \frac{3 \times 1 {0}^{8}}{Frequency \times \sqrt{{ε}_{n}}} \qquad ( 7 )$$

$${η}_{η} = \sqrt{\frac{{μ}_{n} \times {μ}_{0}}{{ε}_{n} \times {ε}_{0}}} , {ε}_{0} = 8.854 \times 1 {0}^{- 12} F \cdot {m}^{- 1} , {μ}_{0} = 4 π \times 1 {0}^{- 7} H \cdot {m}^{- 1} \qquad ( 8 )$$

It is noted that the terms included in equations (5)-(8) have been described and defined above. In the graphical representation 600, an x-axis 602 corresponds to thickness values ranging from 0.2 millimeters to 3.0 millimeters of the second substrate 104, and the y-axis 604 corresponds to reflections coefficients ranging from 0.0 to 0.90. The derived reflections illustrated in FIG. 6 may be determined based on the quantitative assumptions described above, namely that the thickness of the first substrate 102 may be 0.5 millimeters, the relative dielectric constant of the adhesive layer 106 may be 3, the thickness of the adhesive layer 106 may be 50 micrometers, and the permeability of the first substrate 102 may be u₀. It is noted that u₀ may have a value of 4π×10-7 H/m. Additionally, the relative dielectric constant of the first substrate 102 may be less than or equal to 4.5.

It is noted that the thickness of the second substrate 104 has a lesser impact on the total reflections from the frequency selective substrate assembly 111 illustrated in FIG. 4 when compared with the impact of the thickness of the first substrate 102. In particular, the impact of the thickness of the second substrate 104 is less as compared to that of the first substrate 102 for the purpose of maintaining the total reflection under 0.7, particularly in a scenario in which a dielectric constant of the second substrate 104 is less than 5.

The derived reflection curves 606, 608, 610, 612, 614, and 616 is representative of the reflections of the second substrate 104 based on varying permittivity values. However, regardless of the variations in permittivity values, these curves indicate a pattern. Specifically, the derived reflection curves 606, 608, 610, 612, 614, and 616 indicate that the reflections are minimized when the thickness of the second substrate 104 is approximately in the range of 1.6 millimeters to 2.6 millimeters, while the reflection curves peak when the thickness of the second substrate 104 is approximately in the range of 0.6 millimeters to 1.0 millimeter and from approximately 2.6 millimeters to 3.0 millimeters.

It is noted that the parameters included in the equations above and the thickness values described are determined based on and correspond to an operational frequency of 28 GHz. In embodiments, if the operational frequency is increased, e.g., to 39 GHz, the values that are determined above may vary and the thicknesses of the first substrate 102 and the second substrate 104 will be lower.

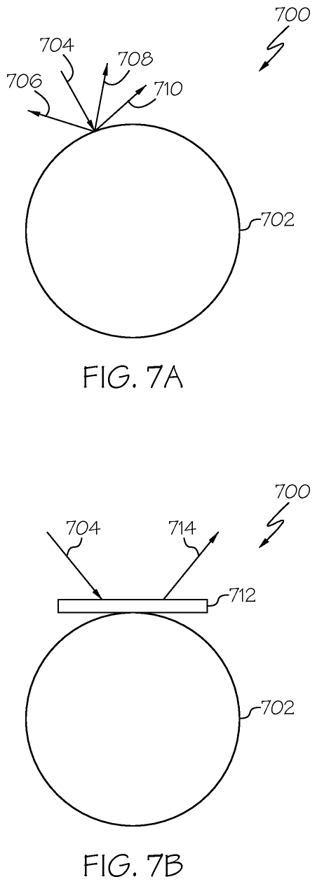

FIG. 7A depicts a signal 704, such as a 28 GHz signal, contacting an object 702 and scattering in multiple directions. As illustrated, an example signal 704, which may be generated by a base station, may contact a surface of the object 702 and scatter in multiple directions, as indicated by example scattered signals 706, 708, and 710. The scattering of the example signal 704 results in signal loss.

By way of contrast, FIG. 7B depicts another representation of the object 702 further comprising a reflector 712 comprising a frequency selective substrate assembly according to one or more embodiments shown and described herein. In particular, a signal 704 contacts the reflector 712 and is reflected in a particular direction, according to one or more embodiments described and illustrated herein. As illustrated, an example signal 704 may contact an outer surface of the reflector 712 and be reflected with a significant degree of fidelity such that instances of signal scattering, as illustrated in FIG. 7A, are reduced. For example, as illustrated in FIG. 7B, the example signal 704 may contact the outer surface of the reflector 712 and be reflected uniformly, as shown by reflected signal 714, in a particular direction. It is noted that the reflector 712 may be positioned in various locations such as, e.g., the exterior surfaces of buildings, interior surfaces of buildings, and so forth. In embodiments, the reflector 712 may have designed to have dimensions of 300 by 300 square millimeters. In embodiments, a plurality of the reflectors 712 may be positioned as part of a grid pattern on various surfaces, as a result of which the surface area from which a signal may reflect is increased. Consequently, instances of signal loss due to scattering are reduced. It is also noted that a variation in the operational frequency may allow for a variation in the dimensions of the reflector 712 while maintaining a threshold level of operational effectiveness. For example, if an operational frequency is increased from 28 GHz to 39 GHz, the dimensions of the reflector 712 may be decreased.

For the purposes of describing and defining the present inventive technology, it is noted that reference herein to a variable being a “function” of a parameter or another variable is not intended to denote that the variable is exclusively a function of the listed parameter or variable. Rather, reference herein to a variable that is a “function” of a listed parameter is intended to be open ended such that the variable may be a function of a single parameter or a plurality of parameters.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A frequency selective substrate assembly comprising:
a first substrate and a second substrate each comprising an inner surface opposite an outer surface;
a conductive material layer disposed on the inner surface of the second substrate; and
an adhesive layer disposed between the inner surface of the first substrate and the inner surface of the second substrate such that the conductive material layer is positioned between the inner surface of the second substrate and the adhesive layer and the adhesive layer bonds the first substrate to the second substrate, wherein the frequency selective substrate assembly comprises a reflection coefficient of 0.7 or less.

2. The frequency selective substrate assembly of claim 1, wherein the conductive material layer comprises a transparent conductive oxide, a conductive polymer, a carbon nanotube wire, graphene, or a metal mesh.

3. The frequency selective substrate assembly of claim 1, wherein each of the first substrate and the second substrate comprises glass having an average transmittance greater than 80% over a wavelength range from about 300 nm to about 800 nm.

4. The frequency selective substrate assembly of claim 1, wherein the adhesive layer comprises a material having a tensile strength that is equal to or greater than 1 Newton per centimeter.

5. The frequency selective substrate assembly of claim 1, wherein the adhesive layer comprises an average transmittance greater than 80% over a wavelength range from about 300 nm to about 800 nm.

6. The frequency selective substrate assembly of claim 1, wherein the frequency selective substrate assembly comprises the reflection coefficient of 0.7 or less at an operation frequency of 28 GHz.

7. The frequency selective substrate assembly of claim 1, wherein a dielectric constant of the adhesive layer is in a range of 2 to 4 and a thickness of the adhesive layer is in a range of 25 micrometers to 175 micrometers.

8. The frequency selective substrate assembly of claim 1, wherein a thickness of the first substrate is different than a thickness of the second substrate.

9. The frequency selective substrate assembly of claim 1, wherein an electric conductivity of the conductive material layer is greater than or equal to 1 million Siemens per meter (S·m⁻¹).

10. The frequency selective substrate assembly of claim 1, wherein the second substrate comprises an opaque material.

11. A frequency selective substrate assembly, comprising:
a first substrate and a second substrate each comprising an inner surface opposite an outer surface;
an adhesive layer disposed between the first substrate and the second substrate, the adhesive layer coupling the first substrate to the second substrate;
a first conductive material layer deposited on the inner surface of the first substrate; and
a second conductive material layer deposited on the inner surface of the second substrate, wherein the frequency selective substrate assembly comprises a reflection coefficient of 0.7 or less.

12. The frequency selective substrate assembly of claim 11, wherein each of the first conductive material layer and the second conductive material layer comprises a transparent conductive oxide, a conductive polymer, a carbon nanotube wire, graphene, or a metal mesh.

13. The frequency selective substrate assembly of claim 11, wherein each of the first substrate and the second substrate comprises glass having an average transmittance greater than 80% over a wavelength range from about 300 nm to about 800 nm.

14. The frequency selective substrate assembly of claim 11, wherein the adhesive layer comprises a material having a tensile strength that is equal to or greater than 1 Newton per centimeter.

15. The frequency selective substrate assembly of claim 11, wherein the adhesive layer comprises an average transmittance greater than 80% over a wavelength range from about 300 nm to about 800 nm.

16. The frequency selective substrate assembly of claim 11, wherein the frequency selective substrate assembly comprises the reflection coefficient of 0.7 or less at an operation frequency of 28 GHz.

17. The frequency selective substrate assembly of claim 11, wherein a dielectric constant of the adhesive layer is in a range of 2 to 4 and a thickness of the adhesive layer is in a range of 25 micrometers to 175 micrometers.

18. The frequency selective substrate assembly of claim 11, wherein a thickness of the first substrate is different than a thickness of the second substrate.

19. The frequency selective substrate assembly of claim 11, wherein an electric conductivity of each of the first conductive material layer and the second conductive material layer is greater than or equal to 1 million Siemens per meter (S·m⁻¹).

20. The frequency selective substrate assembly of claim 11, wherein the second substrate comprises an opaque material.
